(19) United States
(12) Patent Application Publication
(10) Pub. No.: US 2024/0029013 A1
(43) Pub. Date: Jan. 25, 2024

(54) System And Method For Combining Distinct Orders for Single Pickup

(71) Applicant: Nicholas Demes Owens, Sarasota, FL (US)

(72) Inventor: Nicholas Demes Owens, Sarasota, FL (US)

(21) Appl. No.: 18/479,897

(22) Filed: Oct. 3, 2023

(51) Int. Cl. G06Q 10/0836; G06Q 30/0601; G06Q 10/0835

(52) U.S. Cl. CPC G06Q 10/0836; G06Q 30/0635; G06Q 30/0605; G06Q 10/08355; G06Q 10/0838

(57) ABSTRACT

In some embodiments thereof, the present invention discloses a system and method are provided for combining online orders from multiple customers for consolidated pickup or delivery. Customers can attach their orders to other customers' orders by searching or inputting their identifiers. According to one aspect, an algorithm analyzes the orders and determines if they should be aggregated based on factors such as location, order contents and past activity. Once aggregated, the orders are prepared as a single fulfillment by the business, but kept separated. Pickup or delivery is assigned to one customer for streamlined collection.

This creates a seamless single pickup process for group orders rather than individual efforts. Enabled through mobile apps or websites, customers can easily coordinate group purchases from restaurants or any e-commerce vertical. Businesses can optimize fulfillment operations. By simplifying pickup logistics for group orders, this invention solves pain points in online commerce related to fragmented individual purchases. It advances the state of online ordering and delivery for both customers and businesses.

### FIELD OF INVENTION

The present invention relates to the field of online commerce, specifically systems and methods for combining and coordinating multiple customer orders for consolidated pickup or delivery. It streamlines fulfillment of group purchases made through e-commerce platforms by enabling seamless aggregation of orders from multiple individuals. This provides simplification and efficiency improvements in group order fulfillment across industries.

### BACKGROUND OF THE INVENTION

The internet has been a revolutionary force in the world of commerce, reshaping the way consumers access and purchase a vast array of goods and services through various e-commerce platforms and digital marketplaces. Back in the early 2000s, e-commerce was primarily confined to simple online stores and marketplaces, exemplified by the likes of eBay. This era was defined by the ability to order physical goods online, which would then be shipped to customers. However, the purchase of services or perishable items, such as food, remained a rarity due to the complex coordination and fulfillment challenges involved.

As the late 2000s rolled around, a confluence of factors, including faster internet speeds and significant advancements in fulfillment operations, propelled e-commerce into a new era. This wave of transformation gave rise to online food ordering platforms, most notably Grubhub and Seamless, which paved the way for digital services like ridesharing to become bookable through platforms such as Uber.

Fast forward to today, and virtually any consumer product or service can be accessed and ordered online. From clothing to furniture, professional services, groceries, meals, and an extensive array of products, the e-commerce landscape has expanded dramatically. Supply chain operations have evolved to the point where it's now possible to receive purchased items at your doorstep within hours or days. This on-demand economy, while immensely convenient, has also introduced novel challenges.

One such challenge is the inefficiency of purchasing goods in bulk for groups. Businesses still grapple with the intricacies of coordinating group orders from multiple employees for consolidated delivery, while individuals ordering food for events often place separate orders, leading to redundant pickups. This underscores the need for a solution that streamlines group orders for combined purchasing and fulfillment.

The invention at hand seeks to tackle this predicament with a universal system applicable to any e-commerce vertical. It empowers customers to link their orders with those of others, facilitating combined delivery or pickup, ultimately creating a seamless single pickup process. This innovative approach eliminates duplicative efforts for both customers and businesses, enhancing efficiency and reducing logistical hassles.

Looking ahead, the future of e-commerce holds great promise, with emerging technologies like autonomous vehicles, drones, and AI-enabled supply chain platforms poised to further accelerate the industry. However, the core challenge of better order aggregation and simplifying fulfillment for group purchases will remain essential. Streamlining the process of combining orders from multiple customers will bring benefits to a wide range of sectors, spanning from restaurants to retail to B2B procurement.

As the evolution of online commerce continues, consumers will come to expect increasingly sophisticated coordination and fulfillment capabilities. Businesses that can deliver unified experiences across fragmented individual orders will earn customer loyalty and thrive in this rapidly changing landscape.

It is therefore an object of the current invention to establish a comprehensive system and method dedicated to combining and coordinating multiple customer orders, transforming them into consolidated transactions tailored for simplified pickup and delivery. This invention seeks to empower customers by allowing them to seamlessly attach their orders to those of fellow customers, thus engendering aggregated group orders, which can be efficiently prepared and collected in a single, consolidated trip, eliminating the redundancy that has historically plagued the fulfillment of individual orders within the context of group purchases conducted through online platforms. The overarching aim is to optimize the entire process of order aggregation, fulfillment, and collection across a multitude of e-commerce verticals, thereby laying the foundation for a more streamlined and user-centric online shopping experience.

### SUMMARY OF THE INVENTION

The following summary outlines the key innovations embodied in the system, method, devices, and apparatus described herein. It is important to note that this summary provides a concise overview of the invention's core features without intending to impose limitations beyond the scope defined by the detailed description and claims.

In some embodiments thereof, the present invention introduces a novel system for consolidating and coordinating multiple online orders for combined fulfillment. It enables simplified logistics for group purchases from e-commerce platforms.

In one aspect, the invention allows customers to connect their orders to other customers' orders by searching or inputting identifiers like phone numbers or emails. This attachment process can occur when initially placing an order, or after an order is in pending status before pickup.

In another aspect, the system runs intelligent algorithms to analyze pending orders and determine if they should be aggregated. The algorithms may incorporate machine learning models trained on historical order data like customer locations, past group ordering activity, computer identifiers, and other relevant factors. The models output a probability that orders are related and suitable for combining.

In one embodiment, orders predicted to be combinable are aggregated by the business into a single fulfillment package, with contents separated for each customer. Pickup or delivery of the consolidated package is then assigned to one of the associated customers.

This creates a streamlined single pickup process for group orders, rather than individual efforts. Customers avoid repeating the pickup process redundantly. Businesses also optimize operations by preparing fewer packages with aggregated items.

The system maintains flexibility to handle customers that ordered individually but are present together for pickup. Ad hoc combination and handoff can be supported by the trained models detecting locations in proximity.

In one aspect, the invention is universally deployable across e-commerce verticals including food delivery, retail, grocery, transportation and more. Any business fulfilling online orders can benefit from smoother coordination of group purchases.

The system transforms fragmented individual online transactions into seamless collective experiences. Customers enjoy simpler logistics for group events or office orders. Businesses reduce duplicative efforts.

Overall, this invention modernizes online order fulfillment to remove lingering pain points related to grouping separate orders. By enabling ad hoc coordination of multiple customers' purchases, it streamlines a historically disjointed process. This innovation stands to help further increase adoption of online buying across industries.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1 of the drawings illustrates two customers placing food orders and attaching them to each other's orders according to one embodiment.

FIG. 2 of the drawings shows a data table with sample order details used as inputs to a machine learning model according to one embodiment.

FIG. 3 illustrates an order aggregation process where customer orders are analyzed by a machine learning model and assigned to one customer for consolidated pickup according to one embodiment.

FIG. 4 of the drawings demonstrates an order aggregation machine learning model outputting a probability score for combining orders based on input data according to one aspect.

FIG. 5 shows a flow chart of the order placement, aggregation, and simplified pickup process according to one embodiment.

FIG. 6 illustrates Customer 1 searching for Customer 2's order by phone number to attach their order according to one aspect.

FIG. 7 demonstrates Customer 2 entering Customer 1's email so their order will automatically match according to one aspect.

FIG. 8 of the drawings shows a restaurant employee handing the consolidated orders packaged together to Customer 1 according to one embodiment.

FIG. 9 illustrates a delivery driver bringing the combined order to Customer 1 for aggregated group pickup according to one aspect.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

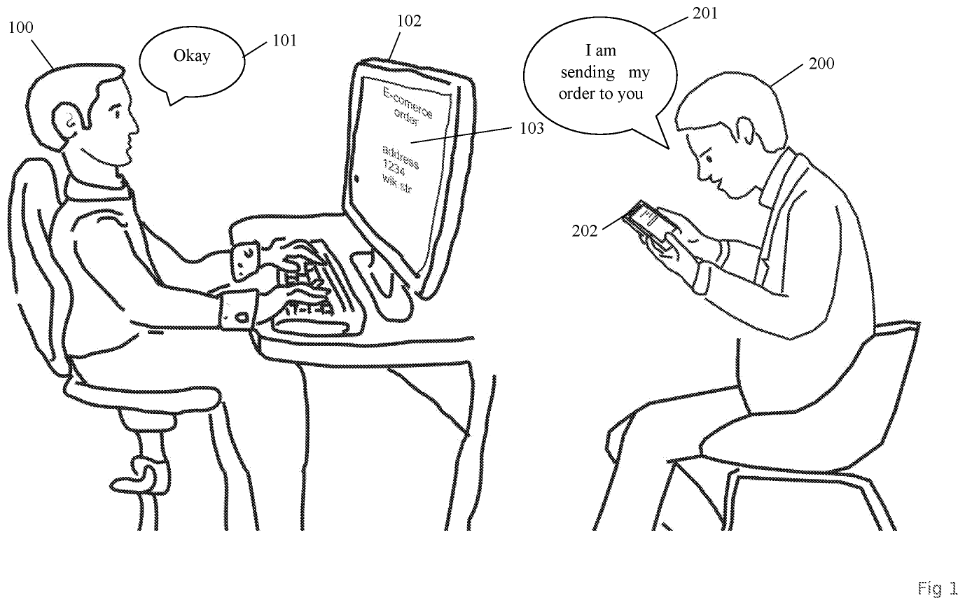

The embodiment according to FIG. 1 presents an illustration of two customers, Customer 100 and Customer 200, seated at their respective desks within an office workspace, engaged in the process of placing online orders for delivery. Customer 100, positioned on the left, is seen utilizing a computer labeled 102 to interact with an e-commerce website, possibly an online food ordering platform. Through this computer, Customer 100 initiates an order, labeled as 103 in the figure, specifying their office address as the delivery location.

Concurrently, at the adjacent desk, Customer 200 is depicted employing a mobile device, which could be a smartphone, denoted as 202, to also initiate an online order on the same e-commerce platform. The intriguing aspect of this illustration lies in the interaction between the two customers. A speech bubble, denoted as 201, emanates from Customer 200, indicating their intention to attach their order to Customer 100's, thus proposing a combined delivery. Customer 200 may state something to the effect of, “I'll send my order to yours for combined delivery,” effectively utilizing the inventive order aggregation system to link their purchase with that of Customer 100 for a consolidated fulfillment.

In response to this proposition, Customer 100, portrayed by speech bubble 101, may readily approve Customer 200's request with a simple, “Okay!” This exchange exemplifies the user-friendly and intuitive nature of the order coordination system, simplifying group order logistics within an office setting, or any similar group setting. The illustration of FIG. 1 offers a tangible representation of how this innovative system streamlines group order coordination, showcasing its practical application in an office environment to facilitate the efficient delivery of combined online purchases. This depiction serves as a compelling illustration of the capabilities of the order aggregation system, which holds the potential to enhance the online shopping experience across various industries, including the corporate workspace.

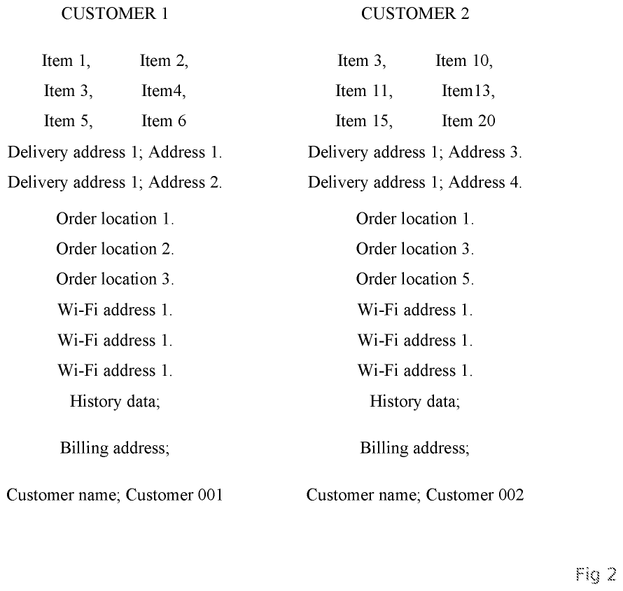

The non-limiting example of FIG. 2 offers a comprehensive view of a data table displaying sample order details for exemplary Customer 1 and Customer 2, preferably intended to serve as inputs to the machine learning model, thereby contributing to the process of determining order aggregation. The table encompasses a diverse set of order data points for each customer, encompassing various facets that are integral to the functioning of the order coordination system.

The data points incorporated in this table include but are not limited to items purchased, the timing of order placement, delivery addresses, order locations, WiFi network addresses, past aggregation activity, and customer names. These parameters provide a holistic view of the contextual factors that influence the decision to aggregate orders, with each facet representing a unique component in the process.

For instance, examining Customer 1's sample data reveals that they have purchased items 1, 2, 3, 4, 5, and 6. The options for delivery addresses encompass Address 1 and Address 2, offering versatility in terms of where the orders can be sent. Order locations span across Location 1, 2, and 3, denoting distinct geographic coordinates, indicative of the locations from which the orders have been initiated. Customer 1's past history showcases a track record of 5 previous order aggregations, which serves as a valuable historical reference for predictive purposes. The individual's name is listed as John Smith, allowing for personalized interactions and record-keeping.

Similarly, for Customer 2, the data provides insight into their ordering patterns. Purchased items include numbers 3, 10, 11, 13, 15, and 20. Delivery addresses consist of Address 3 and Address 4, reflecting their preferences for delivery destinations. Order locations encompass Location 1, 3, and 5, minoring a diverse set of geographic origins for their orders. Past history indicates that Customer 2 has previously engaged in 2 aggregations. The customer's name is identified as Jane Doe, personalizing the interaction and maintaining a record of their activities.

Additionally, the inclusion of WiFi network addresses adds a layer of network connectivity data to the equation. The presence of these addresses can offer insights into whether customers are connected to the same network, which can be a relevant factor in determining order aggregation.

It's essential to underscore that these data points, along with possible variations and supplementary signals such as billing information and customer demographics, all represent potential inputs to the machine learning model. These inputs equip the model with a comprehensive understanding of the factors influencing order aggregation decisions. Features that exhibit strong correlations between orders are more likely to lead the model to assign a higher probability to aggregating them. As a result, the integration of this multifaceted data enriches the decision-making process in the pursuit of streamlining order fulfillment and enhancing the online commerce experience.

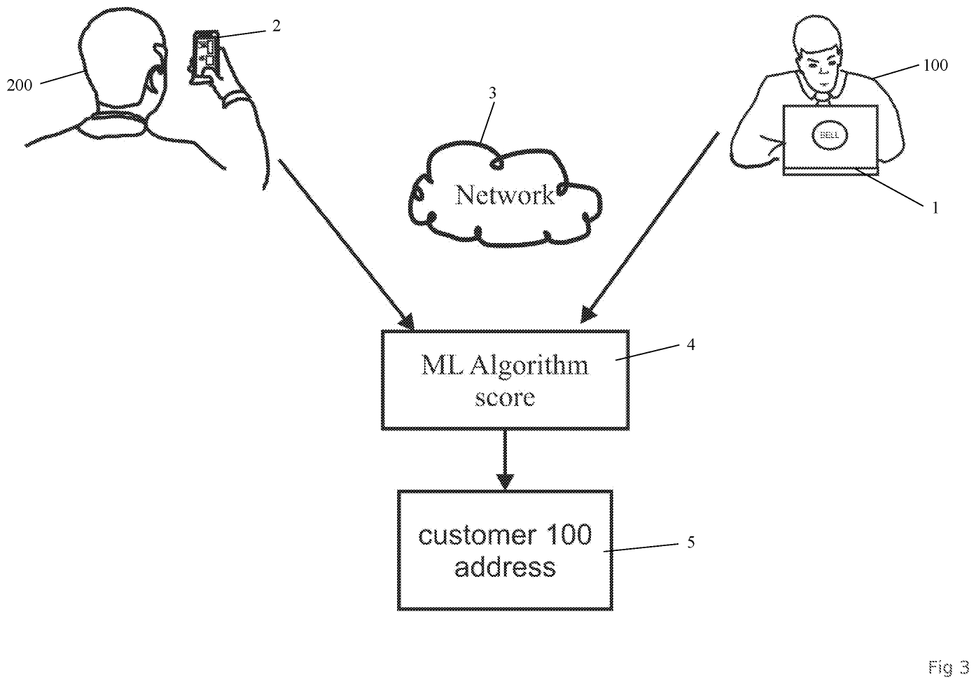

Now making reference to FIG. 3, the order aggregation process is impeccably portrayed, encapsulating the sophisticated operation of the machine learning model within the e-commerce platform. The chart outlines the steps and technology involved in intelligently combining orders for enhanced efficiency.

As an example, the process commences with Customer 100, situated on the right side, who uses their computer 1 to place an order, while Customer 200, located on the left, initiates a distinct order via their smartphone 2.

The data from these orders is seamlessly transmitted over a network connection 3 to the e-commerce platform's backend system. At the core of this backend system lies the machine learning model 4, a component that conducts a comprehensive analysis of the order data.

This machine learning model 4 undertakes the task of scoring the incoming orders, determining their suitability for aggregation based on a range of pertinent features, which may encompass location, order history, and more. The machine learning system calculates the probability of aggregation, taking into account the factors that are critical in the decision-making process.

If the model deems the orders as compatible for aggregation, scoring above a predetermined threshold, it triggers the consolidation of the orders into a single fulfillment. This unified order is then assigned to one of the customer's designated delivery addresses (Single Customer Address 5).

In the scenario depicted, the aggregated order is assigned for delivery to Customer 100, streamlining the logistics by consolidating the items into a single package delivered to Customer 100's address. This approach enhances efficiency by eliminating the need for separate and individual delivery efforts, marking a significant advancement in online commerce.

In essence, FIG. 3 offers a comprehensive visualization of the order aggregation process, where customer orders are meticulously evaluated by a machine learning system to optimize the coordination of pickups and deliveries, ultimately enriching the online shopping experience. This image conveys the technical sophistication and user-centric approach that underscores the order aggregation system, facilitating an efficient and seamless process.

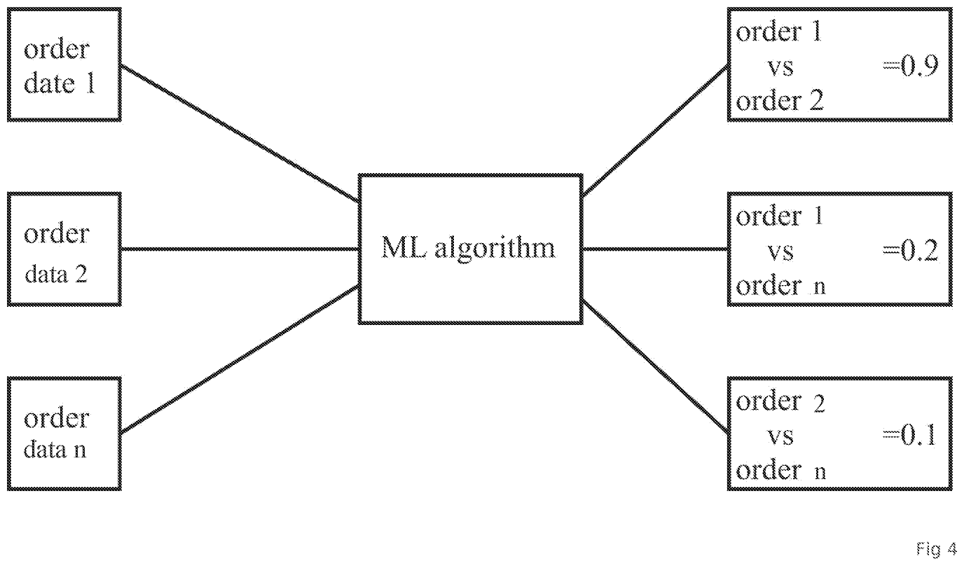

On the other hand, the embodiment according to FIG. 4 provides a comprehensive illustration of the inner workings of the machine learning model (4) which is pivotal for the order aggregation system. This diagram portrays the intricate process of order data being fed into the model and the subsequent determination of aggregation probability, with a representative score of 0.9 as an example. In other words, the diagram effectively portrays the model's ability to analyze input data and produce a probability score, ultimately determining the feasibility of combining orders.

This visual depiction demonstrates the seamless flow of multiple order data inputs, each designated by numbers such as 40, 41, and 42, representing specific orders, including Order 1, Order 2, and Order N. These orders are systematically processed within the trained machine learning model 4, where a rigorous evaluation ensues, considering a myriad of order data features and their correlations to determine their suitability for aggregation.

In one aspect, the outcome of this evaluation is the generation of an aggregation score, serving as a quantifiable representation of the probability that the orders should be consolidated. As exemplified in the example, Order 1 and Order 2 receive an impressive aggregation score of 0.9, signifying a substantial 90% likelihood that they are well-suited for aggregation based on the comprehensive analysis of their respective details.

In contrast, the aggregation scores for Order 1 and Order N, as well as Order 2 and Order N, are notably lower, resting at 0.2 and 0.1 respectively. This indicates a mere 20% and 10% probability that these orders are compatible for aggregation. The machine learning model's discernment and scoring highlight the varying degrees of correlation among the orders, ultimately shaping the aggregation decisions.

In essence, this diagram underlines how the intelligent algorithm within the machine learning model diligently examines multiple facets of order data, effectively predicting the optimal aggregation decisions and streamlining fulfillment logistics. Orders with high correlation scores are seamlessly combined into a single fulfillment package, enhancing the efficiency of the online shopping experience, while unrelated orders are judiciously kept separate. FIG. 4 represents a pivotal component within the order coordination system, showcasing its capability to make data-driven and informed decisions for a more streamlined and user-centric e-commerce process.

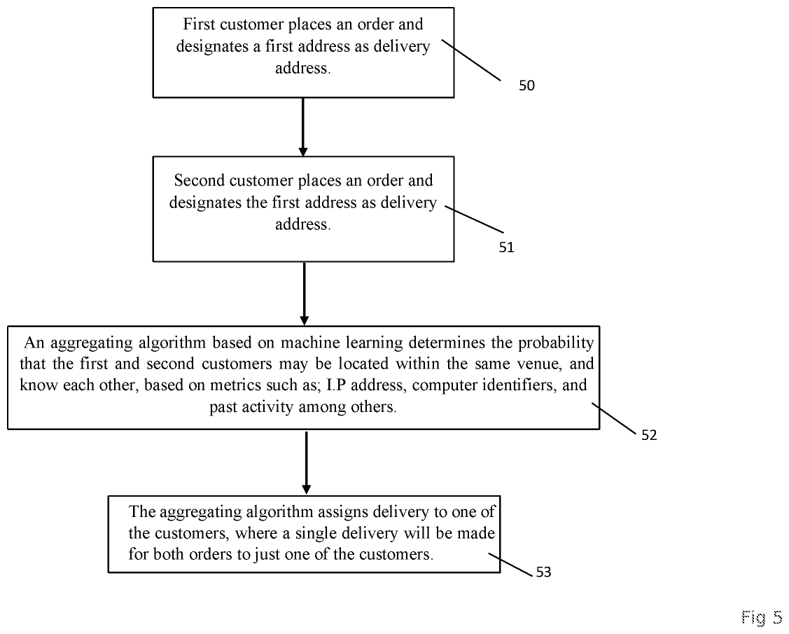

Reference is now made to FIG. 5, which serves as an illustrative flowchart, delineating the exemplary systematic steps that describe the order aggregation process within the order coordination system. This diagram provides a detailed representation of the order placement and aggregation procedure, highlighting the system's intelligent capabilities.

According to one aspect, the sequence commences at step 50, where the first customer initiates an order. As an illustrative example, this customer designates a specific delivery address, such as “123 Main Street,” reflecting the ability of users to specify their preferred delivery location during the online shopping process.

Proceeding to step 51, a second customer also engages in order placement, a common occurrence in the e-commerce realm. In this scenario, the second customer mirrors the delivery preferences of the first customer, selecting the same address, “123 Main Street,” as the delivery location for their order. This action underscores the possibility of aggregation, as both customers express their intent to have their orders delivered to the same destination.

The step 52 marks a pivotal juncture in the process, where the aggregation algorithm, driven by machine learning capabilities, takes the reins. This algorithm embarks on a comprehensive evaluation that may encompasses numerous data points, including but not limited to IP addresses, computer identifiers, and past activity among other factors. For instance, it may assess whether both customers share the same IP address, indicating that they may be located within the same venue. The algorithm's intricate analysis is instrumental in determining the probability of the first and second customers' potential correlation or association.

Further, at step 54, the aggregation decision and delivery assignment reach their culmination. In instances where the algorithm assigns a high likelihood of correlation, it designates the responsibility of delivery to one of the first or second customers. As a practical illustration, if the algorithm determines a strong probability of association, it might choose to assign the delivery to the first customer, thereby streamlining logistics by ensuring a single delivery for both orders. This embodies the core objective of the order coordination system, exemplifying the reduction of duplicative efforts and the enhancement of efficiency in the fulfillment process.

The FIG. 5 provides a visual representation of the sequential process by which the order aggregation system efficiently correlates orders based on various data points, employing the power of machine learning for intelligent decision-making.

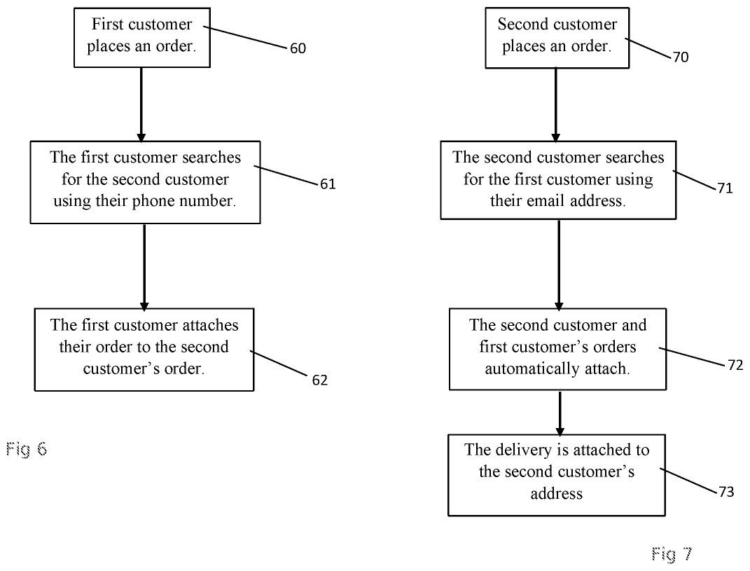

The embodiment according to FIG. 6 illustrates a first customer searching for a second customer order by phone number to attach their order according to one aspect. At step 60, the first customer places an order. This step signifies the standard action taken by a user in the e-commerce platform, exemplified by the customer placing their order, which may include various items, delivery preferences, and more.

In the subsequent step 61, the first customer takes the initiative to search for the second customer, aiming to establish a connection between their respective orders. This search can be executed using the second customer's phone number, email, or any other suitable identifier, enabling a seamless and efficient order attachment process.

Upon locating the second customer, step 62 showcases the action of attaching the first customer's order to the second customer's order, thus demonstrating the user's ability to combine their order with another customer's order, streamlining the fulfillment process.

In practical terms, this could translate to a scenario where a first customer, who has placed an order for office supplies, locates the second customer using their email address. They discover that the second customer has also ordered office-related items. In response, the first customer attaches their order to the second customer's order, creating a consolidated order for more efficient fulfillment.

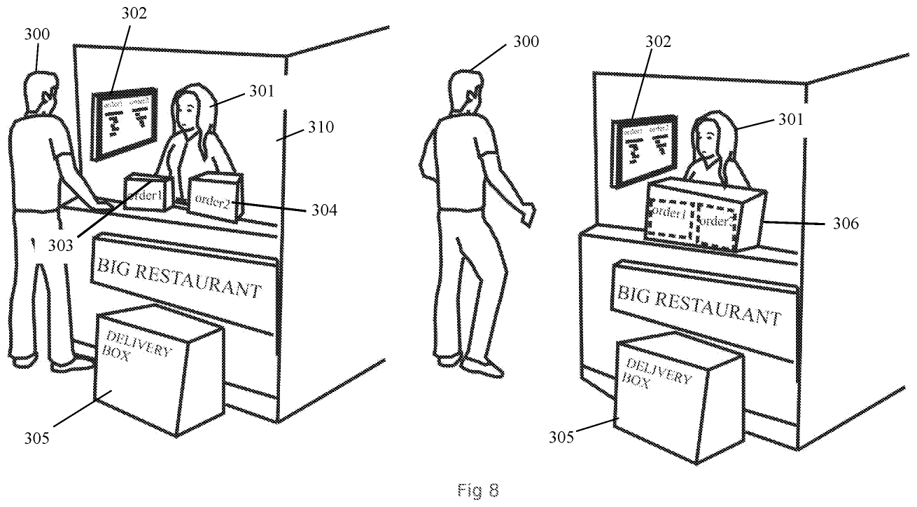

The illustration process of FIG. 7 demonstrates a second customer entering a first customer email so their order will automatically match according to one aspect. The process initiates at step 70, where the second customer, proceeds to place an order through the e-commerce platform. This order may encompass various items, preferences, and details tailored to the second customer's requirements.

In step 71, the second customer undertakes the action of searching for the first customer using their email address. This process enables the second customer to locate the first customer's order, an important step in the automated order attachment process. By providing the first customer's email address, the second customer initiates the connection.

The flowchart progresses to step 72, which is a pivotal stage in the process. At this juncture, the second customer and the first customer's orders are automatically attached. This action reflects the system's capability to intelligently correlate the orders based on the email provided, streamlining the aggregation process.

The step 73, addresses the delivery aspect of the process. The delivery for the combined orders is attached to the second customer's address. This indicates that the aggregated orders will be fulfilled and delivered to the second customer's specified delivery location.

In practical terms, this flowchart can be exemplified by the following scenario: The second customer places an order for office supplies and, upon searching for the first customer using their email address, discovers that the first customer has also ordered office-related items. The system then automatically attaches both orders, streamlining the fulfillment process.

Furthermore, the delivery is assigned to the second customer's address, ensuring efficient and convenient delivery logistics.

The FIG. 8 of the drawings shows a restaurant employee handing the consolidated orders packaged together to according to one embodiment. The figure illustrates the order consolidation and delivery process within a restaurant setting, offering a detailed representation of how aggregated orders are efficiently managed and dispatched.

The main characters in this scenario are the delivery person 300 and the restaurant employee 301. The restaurant employee is responsible for coordinating the aggregated orders, while the delivery person is tasked with ensuring the successful dispatch of the consolidated order. At the center of this process is the restaurant 310, where food orders are prepared and readied for delivery.

An important demonstration of this illustration is the aggregated order 302, which combines two individual customer orders, denoted as Order 303 and Order 304. The aggregation process occurs behind the scenes, streamlining the fulfillment process and enhancing efficiency.

The aggregated orders, now consolidated into a single package 306. This consolidation is a fundamental aspect of the order coordination system, which aims to minimize duplication of efforts and enhance the customer experience.

The delivery box 305 may be a receptacle for the consolidated order, ensuring that it is securely transported and delivered to one of the customers.

In practice, the restaurant employee 301 may receives the aggregated order 302, which includes two individual orders, Order 303 and Order 304. Recognizing that these orders have been aggregated, they prepare both orders for delivery as a single package, ensuring that the delivery person 300 receives the consolidated delivery 306. The delivery person places the consolidated order in their delivery box 305 and dispatches it to one of the customers, simplifying the logistics and improving the overall delivery experience.

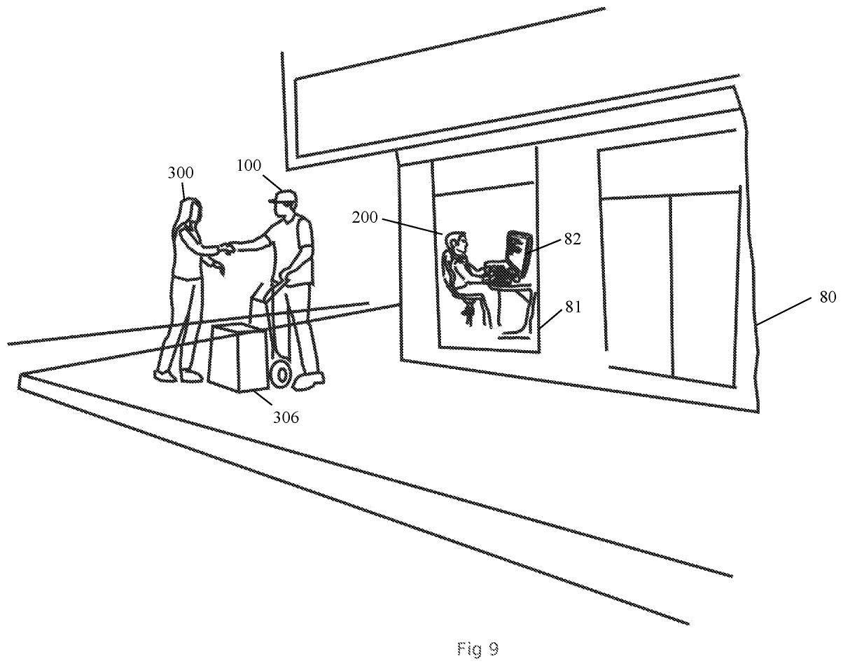

Now referring to FIG. 9 illustrates a delivery driver bringing the combined order to Customer 100 for aggregated group pickup according to one aspect, highlighting the interaction between the delivery person, customer 100, and the office where customer 200 is situated.

The delivery person 300, responsible for ensuring the successful delivery of the consolidated order. The key element in this illustration is the consolidated delivery 306, which represents the aggregated orders that have been prepared for delivery. Customer 100 is shown receiving the consolidated order, symbolizing the successful delivery to one of the customers. In this scenario, customer 100 is outside the building, collecting their order.

Also depicted in the figure, is customer 200 represented as being inside the office. The presence of customer 200 in the office becomes significant, as it signifies their potential involvement in the aggregated order or their role as a recipient in a separate delivery by customer 100.

In this aspect, the delivery person 300 arrives to hand over the consolidated delivery 306 to customer 100, who is waiting outside the building. This visualizes the convenience and efficiency of the order coordination system, demonstrating how aggregated orders are successfully fulfilled and delivered to the customers. Meanwhile, the customer 200 inside the office may in separate deliveries or future interactions be preferred for delivery, underscoring the system's adaptability and user-centric approach to order coordination based on certain circumstances.

In a non-limiting embodiment, it may be provided a means for notifying customers of aggregated order status.

In a non-limiting embodiment, it may be provided a means for determining geographic proximity of customer addresses.

In a non-limiting embodiment, it may be provided a means for billing and payment module for customers to settle payments related to their coordinated orders.

In a non-limiting embodiment, it may be provided a means for generating identifier data for matching orders.

In a non-limiting embodiment, it may be provided a means for optimizing delivery routes.

In a non-limiting embodiment, it may be provided a means for outputting pickup instructions

The innovative system of consolidating and coordinating online orders can be implemented through at least two distinct approaches: a standalone system or a distributed architecture. In the standalone system, the entire order aggregation and analysis process takes place locally on a single device. Conversely, in a distributed setup, client devices such as smartphones or websites gather order data and transmit it to a central server, which handles the resource-intensive aggregation algorithms before returning fulfillment instructions to the clients.

The choice of implementation depends on a variety of factors, including real-time processing requirements, the volume of data being processed, and security considerations. Specific applications may also influence the choice—for instance, an internal system for a restaurant might favor the standalone setup for its simplicity, while a third-party delivery application would likely opt for the distributed architecture to manage data from various sources.

The order coordination invention is versatile and can manifest in multiple forms, including as a method, a system, or a computer program product, seamlessly integrating both hardware and software components. The innovative order aggregation steps can be enabled through computer-readable instructions that guide a general-purpose processor in executing the novel functions as outlined. These instructions can be encapsulated in storage media, allowing for the execution of these inventive processes.

It is essential to acknowledge that experts in the field may identify potential variations, substitutions, and additions within the spirit and scope of the invention. Such foreseeable modifications are fully intended to be encompassed by this invention. The use of singular or plural terms is meant to be interpreted expansively, unless otherwise constrained by context.

In sum, the applicant aims to encompass reasonable alterations and integrations that align with the primary goal of streamlining online order fulfillment through effective coordination.

### INDUSTRIAL APPLICATION

The invention described herein finds significant industrial application across industries and e-commerce verticals. It can be deployed by restaurants, retailers, grocery stores, transportation providers, or any business fulfilling online orders, to optimize their fulfillment operations. By aggregating individual customer orders into consolidated pickups and deliveries, businesses can save on labor, packaging, and transportation costs. Fewer drivers are needed and customers have simplified logistics. Industries from food delivery to B2B procurement can benefit from streamlined coordination of group purchases. This invention modernizes order fulfillment to meet the evolving omni-channel commerce landscape.

What is claimed is:

1. A system for consolidating online orders from multiple customers for simplified fulfillment comprising:
a. an interface configured to receive customer order data;
b. a processing engine configured to analyze the order data to determine related orders suitable for aggregation;
c. an aggregation engine configured to combine related orders into a single fulfillment package while keeping order contents separated, and;
d. a coordination engine configured to assign consolidated fulfillment to one of the associated customers.

2. The system of claim 1, wherein the machine learning algorithm analyzes order data including but not limited to IP addresses, customer identifiers, past order history, and order content to determine consolidation probability.

3. The system of claim 1, wherein the interface receives identifier data for matching orders.

4. The system of claim 1, wherein the coordination engine optimizes delivery routes.

5. The system of claim 1, wherein order data comprises customer locations.

6. The system of claim 1, wherein the interface connects to e-commerce websites.

7. A computer program product for consolidating online orders from multiple customers for simplified fulfillment comprising computer-readable instructions stored on a non-transitory computer-readable medium that when executed by a processor cause a computer to:
a. receiving individual customer orders through a user interface;
b. employing a machine learning algorithm to analyze the orders and determine the probability of order consolidation based on predefined criteria;
c. aggregating orders identified by the machine learning algorithm, and;
d. designating a single delivery point for the consolidated orders.

8. The computer program product of claim 7, wherein analyzing order data comprises predicting aggregation probability with a machine learning model.

9. The computer program product of claim 7, wherein the instructions further cause receiving identifier data for matching orders.

10. The computer program product of claim 7, wherein assigning fulfillment comprises optimizing delivery routes.

11. The computer program product of claim 3, wherein order data comprises computer identifiers.

12. The computer program product of claim 3, wherein instructions assign ad hoc orders.

13. A method for consolidating online orders from multiple customers for simplified fulfillment comprising:
a. receiving customer order data through an interface;
b. analyzing the order data to determine related orders suitable for aggregation;
c. combining related orders into a single fulfillment package while keeping order contents separated, and;
d. assigning consolidated fulfillment to one of the associated customers.

14. The method of claim 13, wherein analyzing order data comprises predicting aggregation probability with a machine learning model.

15. The method of claim 13, further comprising receiving identifier data for matching orders.

16. The method of claim 13, wherein assigning fulfillment comprises optimizing delivery routes.

17. The method of claim 13, wherein order data comprises past customer activity.

18. The method of claim 13, further comprising outputting pickup instructions.
